(19) United States
(12) Patent Application Publication
(10) Pub. No.: US 2003/0011716 A1
(43) Pub. Date: Jan. 16, 2003

(54) Commercial attenuator

(76) Inventor: Peter Vogel, Faulconbridge (AU)

Correspondence Address: FISH & RICHARDSON, PC, 4350 LA JOLLA VILLAGE DRIVE, SUITE 500, SAN DIEGO, CA, 92122, US

(21) Appl. No.: 10/182,343

(22) PCT Filed: Jan. 25, 2001
(86) PCT No.: PCT/AU01/00068

(30) Foreign Application Priority Data
Jan. 28, 2000 (AU) PQ 5305

(51) Int. Cl. H04N 3/24

(52) U.S. Cl. 348/633; 348/634

(57) ABSTRACT

A system and process which renders commercials less intrusive by reducing the intensity of the sound or picture or both during a commercial break. Whereas prior-art commercial deleters disable the sound or picture of a program during commercials, the present invention offers the advantage of being able to watch listen to commercials if desired while reducing their intrusiveness.

### FIELD OF THE INVENTION

The present invention relates to television and radio receiving and recording equipment, in particular systems for reducing the volume during commercial breaks.

### BACKGROUND OF THE INVENTION

It is widely recognised that commercial breaks within television or radio programs are a source of annoyance to many people. Many systems have been proposed for removing commercials or other unwanted material from programs. One effective system is described in U.S. Pat. No. 5,371,795 to Vogel which is hereby incorporated by reference for all purposes. In Vogel's system, a number of people monitor broadcasts as they go to air. These people then enter data into a computer as the content of a channel changes. When a commercial starts on a particular channel, the monitoring person presses a button that causes a signal to be transmitted to viewers' homes indicating that a commercial is in progress on the channel concerned. Equipment at the viewer's home recognises this signal, and if the channel indicated by the signal is being viewed or recorded, the television receiver or video recorder is disabled until the commercial break is finished, as indicated by receipt of another signal constituted for this purpose.

Other systems, such as pattern recognition systems that recognise commercials, have been developed for removing commercials.

While such commercial deleters have considerable utility, they suffer the limitation that they generally completely cut out the sound, and possibly the picture as well, during commercial breaks. Some people find this abrupt disappearance of sound or picture to be disturbing. It has also been found that the sudden resumption of sound after the commercial break is alarming to some people, while other people find the complete absence of sound annoying in cases where a commercial that is new to them is visible but inaudible. Furthermore, in some cases it has been suggested that such editing of programs could violate the integrity of the broadcast and hence breach copyright laws.

### SUMMARY OF THE INVENTION

It is an object of this invention to provide a system and process which renders commercials less intrusive by reducing the intensity of the sound or picture or both during a commercial break.

In one embodiment, the present invention provides a commercial attenuator comprising an attenuator and a commercial detector arranged to control the attenuator.

In certain embodiments the attenuator comprises an audio attenuator.

In other embodiments the attenuator comprises a video attenuator.

In yet another embodiment, the present invention provides an entertainment set comprising a program receiver, a monitor, an attenuator receiving program from the program receiver and feeding program to the monitor, and a commercial detector arranged to control the attenuator.

In certain embodiments the entertainment set is a television set.

In other embodiments the entertainment set is a radio set.

In yet another embodiment, the present invention provides a program recording set comprising a program receiver, a recorder, an attenuator receiving program from the program receiver and feeding program to the recorder, and a commercial detector arranged to control the attenuator.

In certain embodiments the program recording set is a video recorder.

In certain embodiments the program recording set is an audio recorder.

In some embodiments of the invention the attenuator is arranged to provide a preset degree of attenuation.

In other embodiments, the attenuator is provided with control means for allowing the user to adjust the degree of attenuation as desired.

In some embodiments of the invention the degree of attenuation of the video signal and the degree of attenuation of the audio signal can be adjusted independently.

In some embodiments, the commercial detector comprises a receiver which receives signals indicating when a commercial break is in progress from a remote transmitter.

In one embodiment, the commercial detector comprises an interface which connects to a computer, said computer being adapted to receive data indicating when a commercial break is in progress from the internet.

In other embodiments, the commercial detector monitors the received program and determines when a commercial break is in progress.

### DESCRIPTION OF PREFERRED EMBODIMENT

An embodiment of the invention will now be described with reference to the drawings in which:

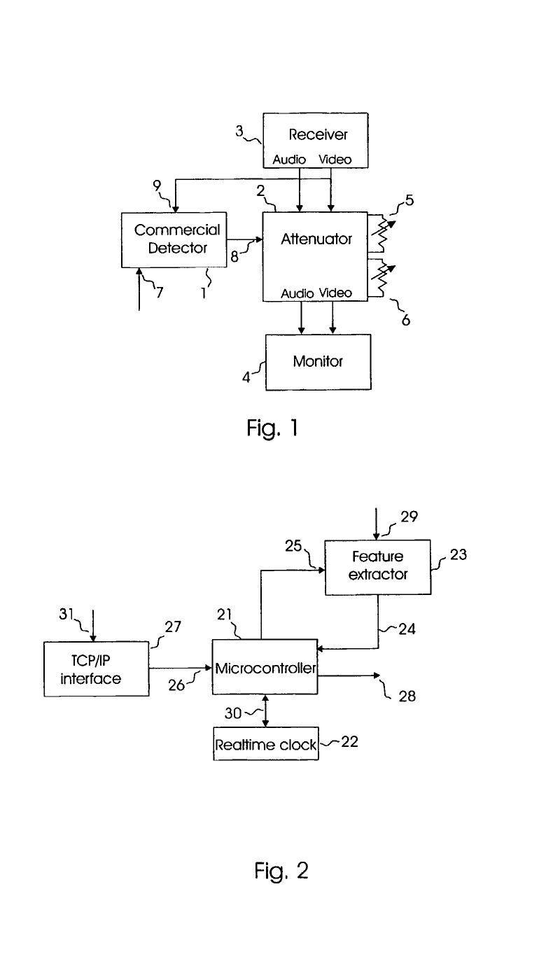

FIG. 1 is a block diagram of an embodiment of the present invention utilizing signals from the internet to detect commercial breaks and to determine which channel is being viewed; and

FIG. 2 is a block diagram of a particular implementation of the commercial detector used in this embodiment of the invention.

Referring now to FIG. 1, receiver 3 is a conventional television tuner. For convenience this may be part of a video cassette recorder (VCR). Audio and video outputs from receiver 3 are fed to the inputs of attenuator 2, which comprises two attenuators, one for the video signal and the other for the audio signal. The audio and video outputs from the attenuator feed a television monitor.

The control input 8 of attenuator 2 is a digital control signal, which when at a logical 0 state causes attenuator 2 to pass signals straight through unattenuated, and when at logical 1 state causes the audio signal to be attenuated according to the level set by potentiometer 5 and the video signal to be attenuated according to the level set by potentiometer 6.

Under normal viewing circumstances control input 8 is at a logic zero state and therefore the television program is passed from receiver to monitor unmodified.

Commercial detector 1 receives control signals from control input 7, which in this embodiment is a connection to the internet. This connection can be conveniently provided by a cable modem fed by the same cable that provides the video programs being viewed. Commercial detector 1 also receives, at input 9, the video signal from receiver 3. The operation of commercial detector 1 is described in detail below with reference to FIG. 2.

When commercial detector 1 determines that a commercial is in progress on the channel being viewed, a logical 1 is sent to control input 8 of attenuator 2, which causes attenuator 2 to attenuate the audio and video signals according to the settings of potentiometers 5 and 6.

The result is that the sound level and picture contrast are reduced during the commercial breaks.

It will be understood by those skilled in the art that the video attenuator of this 30 invention should attenuate the picture component of the video signal without changing the synchronising pulses, so that the picture does not become unstable when it is attenuated.

Referring now to FIG. 2, the operation of the commercial detector section of this embodiment will now be described. The components of the commercial detector provide two main functions; detecting which channel is being viewed, and detecting commercial breaks occurring on that channel. TCP/IP interface 27 receives TCP/IP data packets from the interet via input 31 once per second. These packets describe the instantaneous commercial status of each of a plurality of channels available for viewing. In this embodiment, such data is structured as six eight bit bytes, providing 48 bits which indicate the presence of a commercial break on each of 48 television channels.

Because it is necessary to control the attenuator of the invention according the commercial status of only the particular channel being viewed, the commercial detector needs to be aware of the current channel. In this embodiment, microcontroller 21 is arranged to calculate the current channel by monitoring the video signal arriving at input 29 of feature extractor 23, performing analysis of the picture content, and comparing this to picture data which is also received from the internet at input 31. This source provides picture data for each of the possible channels, and microcontroller 21 determines which channel best matches the channel being viewed as sampled at input 29.

Picture analysis is achieved with the assistance of feature extractor 23, which in this embodiment is circuitry arranged to sample a particular region of the picture and measure the average luminance level within that region. In this embodiment, the picture is divided into an array of 16×16 regions by hardware within feature extractor 23. The region of interest is addressed according to data supplied to input 25 of feature extractor 23 by microcontroller 21, the luminance value being sent to microcontroller 21 from output 24 of feature extractor 23. Microcontroller 21 reads the luminance value of each of the 256 regions ten times per second and stores these values in a circular buffer capable of holding 50 sets of readings.

At a remote site connected to the internet (not shown) a computer is arranged to continuously monitor the picture content of all television channels to be controlled. This computer is equipped with feature extraction means similar to feature extractor 23, except that the feature extractor at the remote site must be capable of processing many independent channels of video signals simultaneously. The computer's software is arranged to continuously examine the luminance data of each channel and to determine which of the 256 regions of the picture can most reliably be used to uniquely identify channels. For example, it may be that the top left corner of the picture on channel 10 has increased luminance over the preceding second in a way which is very distinctive compared to all other channels. The computer will therefore select this as a unique channel identifier, and generate a message conveying the information to the effect that “if the luminance in region 18 increased in the last second, the channel being watched is 10”. This is encoded into a compact format and transmitted to the internet for reception by the commercial detectors of the present invention.

This TCP/IP data is received by TCP/IP interface 27 via internet connection 31, and passed to microcontroller 21 which uses the data to determine which channel's data best matches the data it has stored from feature extractor 23.

Because of the latency in the internet, the data packets also carry timestamps which enable microcontroller 21 to compensate for indeterminate propagation delays. Realtime clock 22 facilitates this by providing an accurate time reference from which microcontroller 21 can calculate the correct stored data to examine.

This arrangement for determining channels is somewhat complex, however it has the advantage that the invention can be used with a standard video receiver, which has no accessible output for detecting the channel selection directly. In other embodiments, other means of determining the channel can be used. For example, if the invention is built into a VCR or television receiver, direct connection to the tuner system will provide the commercial detector with channel information. Alternatively, an infra-red receiver can be used to receive the remote-control signals used to select the channel.

In this embodiment, channel identifying data and commercial status data for all channels are transmitted continuously. This is somewhat wasteful of bandwidth in cases where the channel being viewed is known, for example if the invention is incorporated into a VCR. In such cases a variation on the above-described embodiment is possible wherein the invention connects to a remote server which serves only the data relating to the channel of interest. In this case no data is sent while program is in progress. When a commercial break starts on the channel of interest, data is sent indicating a commercial in progress. This data is repeated periodically, say every second, until the commercial break is finished, at which time an “end of commercial break” message is sent. Reception of the “end of commercial break” message causes the commercial detector to indicate “no commercial” immediately. Loss of the repeated “commercial in progress” data for more than a preset time, say two seconds, also results in indication of “no commercial”. This provides a failsafe mechanism which fails to the condition of no attenuation.

The commercial-indicating data used by this and other embodiments to indicate presence of commercial breaks can be provided by a number of methods. One effective system is to use a number of people monitoring broadcasts as they go to air. These people then enter data into a computer as the content of a channel changes. Improved methods of performing this monitoring method are described in U.S. Pat. No. 5,371,795 to Vogel. Other systems, such as pattern recognition schemes, can also be utilized with good results.

This embodiment can of course be easily modified to attenuate commercials while recording programs, rather than while viewing. In this case monitor 4 is replaced by a video recorder.

It will also be understood that whereas both embodiments refer to attenuating commercials, the present invention can also be applied with good effect to attenuating material of other types. For example, the function can easily be reversed, so that programs are attenuated and commercial breaks left at full level. Alternatively, particular program types can be accentuated, for example the attenuator can be normally set to attenuate and only during news flashes is the full signal passed through.

It will be understood that certain modifications and extensions of the inventive concept will be obvious to those skilled in the art and can be made without departing from the scope of the present invention.

For example, the invention is applicable to all recording means, including, for example DVD, VCR, and hard-disk based recorders. The invention can also be used for controlling audio recorders.

Whereas the exemplary embodiment herein utilises the internet as the means of conveying control data, it is of course possible to use other conveyance instead, including telephone line, radio signals, FM subcarrier or television vertical interval. In particular, radio paging networks are well suited to this application, since they already exist in most areas serviced by television, and the technology required to receive and decode the signals is simple and inexpensive.

It will also be understood by those skilled in the art that the particular method of detecting which channel is being viewed described in relation to the embodiments above is exemplary only, and many other systems can be used with good result.

The invention can also be incorporated into other equipment, for example built into a VCR, cable set-top box, personal computer or television receiver.

1. A system for selectively controlling the intensity of entertainment program material comprising:
an attenuator; and
a commercial detector arranged to control said attenuator.

2. A system according to claim 1 wherein said attenuator comprises an audio attenuator adapted to attenuate by a factor adjustable by the user.

3. A system according to claim 1 wherein said attenuator comprises an audio attenuator adapted to attenuate by a preset factor.

4. A system according to claim 1 wherein said attenuator comprises a video attenuator adapted to attenuate by a factor adjustable by the user.

5. A system according to claim 1 wherein said attenuator comprises a video attenuator adapted to attenuate by a preset factor.

6. A system for selectively controlling the intensity of entertainment program material comprising:
an audio attenuator;
a video attenuator; and
a commercial detector arranged to control said attenuators.

7. A system according to claim 6 wherein the degree of attenuation of the video signal and the degree of attenuation of the audio signal can be adjusted independently.

8. A system according to any of claims 1-7 wherein said commercial detector comprises a receiver which receives signals from a remote transmitter indicating when a commercial break is in progress.

9. A system according to any of claims 1-7 wherein said commercial detector comprises an interface which connects to processing means, said processing means being adapted to receive from the Internet data indicating when a commercial break is in progress.

10. A system according to any of claims 1-7 wherein said commercial detector comprises an interface which connects to processing means, said processing means being adapted to receive data indicating when a commercial break is in progress from the Internet, and said data includes timestamps.

11. A system according to any of claims 1-7 wherein said commercial detector comprises an interface which connects to processing means, said processing means being adapted to:
receive data indicating whether a commercial break is in progress from the Internet, said data comprising packets transmitted at regular intervals;
command said attenuator to attenuate when said data indicates that a commercial is in progress on a channel of program being received;
command said attenuator to not attenuate when said data indicates that a commercial is not in progress on a channel of program being received; and
command said attenuator to not attenuate if said data packets are not received within a predetermined time.

12. A system according to any of claims 1-7 wherein said commercial detector monitors said entertainment program and determines when a commercial break is in progress according to program content.

13. A system for selectively controlling the intensity of entertainment program material comprising:
an attenuator;
a channel detector adapted to detect which one of a plurality of channels of entertainment program is being received;
an indicating signal receiver; and
a controller responsive to the output of said channel detector and said indicating signal receiver adapted so that while said indicating signal indicates that a commercial is in progress on a channel being received, said attenuator is commanded to attenuate.

14. A system according to claim 13 wherein said channel detector comprises:
a feature extractor adapted to extract features from a program signal;
a data receiver adapted to receive data describing features of each of a plurality of program signals; and
a processor adapted to determine which channel is being received by processing the output of said feature extractor and the output of said data receiver.

15. A system according to claim 13 wherein said feature extractor monitors the video content of a television program signal.

16. A system according to claim 12 wherein said feature extractor monitors the audio content of a television program signal.

17. A system according to claim 13 wherein said feature extractor monitors the video and audio content of a television program signal.

18. An entertainment set comprising a program receiver, a monitor, an attenuator receiving program from the program receiver and feeding program to said monitor, a commercial detector, and a controller arranged to control said attenuator according to output of said commercial detector.

19. A system according to claim 18 wherein the entertainment set is a television set.

20. A system according to claim 18 wherein the entertainment set is a radio set.

21. A program recording set comprising a program receiver, a recorder, an attenuator receiving program from the program receiver and feeding program to said recorder, a commercial detector, and a controller arranged to control said attenuator according to output of said commercial detector.

22. A system according to claim 21 wherein said recorder is a video recorder.

23. A system according to claim 21 wherein said recorder is an audio recorder.

24. A system according to any of claims 1-7, 13-23 wherein the maximum attenuation of said attenuator is limited so that said entertainment program material remains discernable when attenuated.

25. A system for selectively controlling the intensity of entertainment program material substantially as hereinbefore described, with reference to the accompanying drawings.
